(19) United States
(12) Patent Application Publication
(10) Pub. No.: US 2018/0007878 A1
(43) Pub. Date: Jan. 11, 2018

(54) Fishing Bobber

(71) Applicant: Buoy Babies, LLC, Hubert, NC (US)

(72) Inventors: Lora Alison Reid-Jones, Hubert, NC (US); Jason Robert Jones, Hubert, NC (US)

(73) Assignee: Buoy Babies, LLC, Hubert, NC (US)

(21) Appl. No.: 15/637,055

(22) Filed: Jun. 29, 2017

Related U.S. Application Data
(60) Provisional application No. 62/358,704, filed on Jul. 6, 2016.

(51) Int. Cl. A01K 93/00

(52) U.S. Cl. CPC A01K 93/00

(57) ABSTRACT

A fishing float including a buoyant body. The buoyant body may include an upper portion having a general shape of one of a toy, character, or animal; and a lower portion, wherein the lower portion extends from a bottom of the upper portion and is generally ovular in shape, and wherein the upper portion and the lower portion are shaped and configured together such that when floating in water at least a portion of the upper portion is visible above the water. The fishing float may further include a mechanism for adjustably securing the buoyant body to a fishing line.

### RELATED APPLICATIONS

This application claims priority to and incorporates herein by reference related U.S. Provisional Patent Application Nos.: 62/358,704, entitled “Fishing Bobber” filed on Jul. 6, 2016

### TECHNICAL FIELD

The presently disclosed subject matter relates generally to fishing equipment and more particularly to toy-shaped fishing bobber floats for helping to hold the attention and/or interest of children for fishing.

### BACKGROUND

A child's first couple of fishing experiences often determines whether or not the sport is going to become a lifelong passion, or just another thing he or she will grow out of as they progress in years. Fishing should never seem like a boring chore for children, or they will reject it as they would anything that isn't fun. Most children won't have the patience to fish for long, so anything to keep fishing from getting boring can make fishing a great experience that children will love.

### SUMMARY

In one embodiment, the invention provides a fishing float. The fishing float may include a buoyant body, including an upper portion having a general shape including one of a toy, character, or animal; and a lower portion, wherein the lower portion extends from a bottom of the upper portion, and wherein the upper portion and the lower portion are shaped and configured together such that when floating in water at least a portion of the upper portion is visible above the water; and a mechanism for adjustably securing the buoyant body to a fishing line. The lower portion may be one of a generally ovular, pear, or spherical shape. The mechanism for securing the buoyant body to a fishing line may include an elongated catch, including a top catch disposed at the upper portion of the buoyant body and a bottom catch disposed at the lower portion of the buoyant body; a spring-loaded push button configured to actuate one of the top catch or bottom catch; and wherein the top catch and bottom catch are configured to engage with the fishing line to secure the buoyant body thereto. The fishing float may further include a vertically orientated hollow channel formed through upper and lower portions of the buoyant body, wherein the hollow channel is configured to receive fishing line threaded therethrough, and wherein the mechanism for securing the buoyant body to a fishing line may include at least one bobber stop, wherein the bobber stop is disposed at one or both of the top and/or bottom of the buoyant body where the fishing line enters and exits the hollow channel. The lower portion of the buoyant body may be weighted. The lower portion of the buoyant body may be configured to be underwater when in use. The buoyant body may be made of at least one of foam, cork, plastic, wood, or rubber material. The upper and lower portions of the buoyant body may be made of the same material. The upper and lower portions of the buoyant body may be made of different materials. The upper and/or lower portions of the buoyant body may be one of hollow, semi-solid, or solid. The fishing float may further include a vertically orientated slot formed in the upper and lower portions of the buoyant body, wherein the slot extends about halfway through a width of the buoyant body, and is configured to receive fishing line therein, and wherein the mechanism for securing the buoyant body to a fishing line may include at least one peg, wherein the peg is inserted into the slot.

In another embodiment, the invention provides a fishing apparatus. The fishing apparatus may include a fishing rod; a fishing reel attached to the fishing rod, the fishing reel including fishing line; and a fishing float attached to the fishing line. The fishing float may include a buoyant body, the buoyant body may include an upper portion having a general shape such as a toy, character, or animal; and a lower portion, wherein the lower portion extends from a bottom of the upper portion, and wherein the upper portion and the lower portion are shaped and configured together such that when floating in water at least a portion of the upper portion is visible above the water; and a mechanism for adjustably securing the buoyant body to the fishing line.

### BRIEF DESCRIPTION OF THE DRAWINGS

Having thus described the disclosed subject matter in general terms, reference will now be made to the accompanying Drawings, which are not necessarily drawn to scale, and wherein:

FIG. 1 illustrates a front view and a side view of an example of a standard bobber that has a spring-loaded catch to attach to a fishing line;

FIG. 2 illustrates a front view and a side view of a turtle-shaped fishing bobber, which is one example of the disclosed fishing bobber;

FIG. 3 illustrates an example of the disclosed fishing bobber (e.g., the turtle-shaped fishing bobber) attached to the fishing line of a fishing pole;

FIG. 4 through FIG. 21 show other, non-limiting examples of the disclosed fishing bobber;

FIG. 22 illustrates a flow diagram of an example of a method of using the presently disclosed toy-shaped fishing bobbers for helping to hold the attention and/or interest of children for fishing; and

FIG. 23 illustrates a front view and a side view of an example of the disclosed fishing bobber (e.g., the turtle-shaped fishing bobber) that is a slip type of bobber.

### DETAILED DESCRIPTION

The presently disclosed subject matter now will be described more fully hereinafter with reference to the accompanying Drawings, in which some, but not all embodiments of the presently disclosed subject matter are shown. Like numbers refer to like elements throughout. The presently disclosed subject matter may be embodied in many different forms and should not be construed as limited to the embodiments set forth herein; rather, these embodiments are provided so that this disclosure will satisfy applicable legal requirements. Indeed, many modifications and other embodiments of the presently disclosed subject matter set forth herein will come to mind to one skilled in the art to which the presently disclosed subject matter pertains having the benefit of the teachings presented in the foregoing descriptions and the associated Drawings. Therefore, it is to be understood that the presently disclosed subject matter is not to be limited to the specific embodiments disclosed and that modifications and other embodiments are intended to be included within the scope of the appended claims.

In some embodiments, the presently disclosed subject matter provides toy-shaped fishing bobber floats for helping to hold the attention and/or interest of children for fishing. The toy-shaped fishing bobber floats are hereafter called toy-shaped fishing bobbers. The toy-shaped fishing bobbers can be any of an assortment of different shaped and colored fishing bobbers that are designed for children to fish with.

Each of the presently disclosed toy-shaped fishing bobbers includes a body, an elongated catch, and a spring-loaded push button, wherein the body is toy-shaped. The body of the toy-shaped fishing bobbers can be shaped like cute little animals and, in particular, shaped like aquatic animals. For example, the toy-shaped fishing bobbers can be shaped like turtles, penguins, duckies, frogs, octopus, alligators, sharks, whales, dolphins, crabs, seahorses, jellyfish, lobsters, swans, seals, walruses, starfish, stingrays, and other aquatic animals. In other examples, the toy-shaped fishing bobber floats can be shaped like any toy, such as, but not limited to, boats, ships, planes, footballs, soccer balls, cars, trucks, dolls, and various other toys or characters.

The presently disclosed toy-shaped fishing bobbers can be used to make fishing fun for children, especially the part about watching the bobber. By making the bobber a cute little animal or toy the child will enjoy fishing more. The presently disclosed toy-shaped fishing bobbers provide something cute and interesting for children to look at while they fish. Accordingly, the toy-shaped fishing bobbers are designed to keep the attention of children on the bobber longer and enhance the enjoyment of fishing by making it more fun with cute shapes.

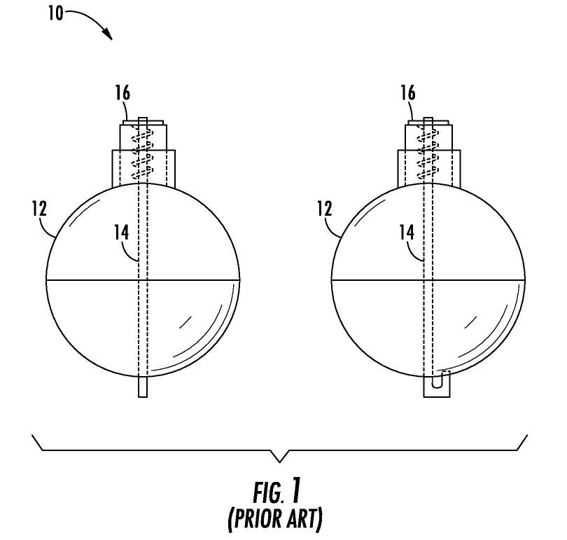

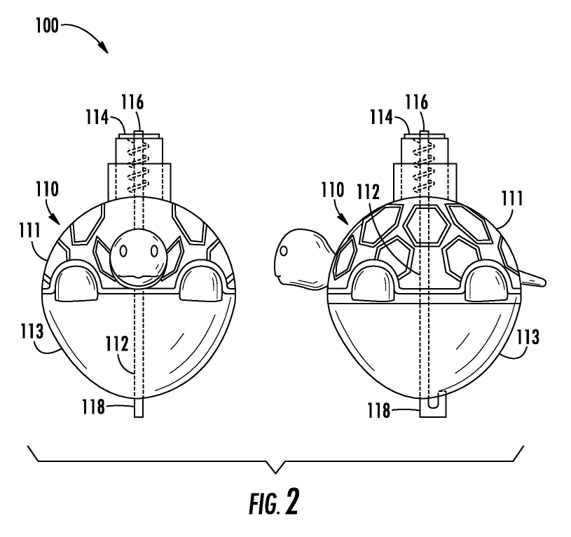

A fishing bobber, also called a fishing float, is used by anglers both to suspend live bait in the water at a desired depth and to see when a fish is biting. Bobbers come in many shapes and sizes but the beginner fisherman is best served by utilizing the typical round red-and-white bobber. By watching the bobber's movements in the water, the user will be able to tell if a fish is nibbling at the bait and can then try to set the hook. For example, FIG. 1 shows a front view and a side view of an example of a standard round bobber 10 that has a spring-loaded catch to attach to the fishing line. Namely, standard round bobber 10 includes a body 12, an elongated catch 14, and a spring-loaded push button 16. In this example, body 12 is a plastic, hollow, sphere-shaped body. In the presently disclosed toy-shaped fishing bobbers, the standard body 12 can be replaced with a toy-shaped body, examples of which are shown in FIG. 2 through 22.

Referring now to FIG. 2 is a front view and a side view of one example of the presently disclosed toy-shaped fishing bobbers 100. Each of the toy-shaped fishing bobbers 100 includes a body 110, an elongated catch 112, and a spring-loaded push button 114. Further, elongated catch 112 has a top catch 116 and a bottom catch 118.

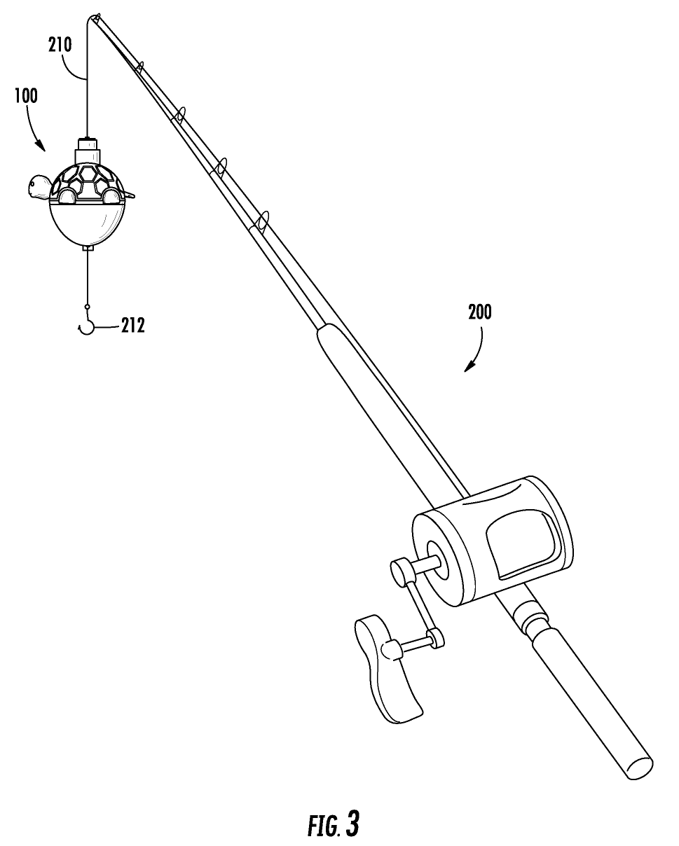

In this example, body 110 of toy-shaped fishing bobbers 100 has a turtle shape. Accordingly, the toy-shaped fishing bobber 100 shown in FIG. 2 is a turtle-shaped fishing bobber 100. FIG. 3 shows an example of a fishing pole 200, wherein turtle-shaped fishing bobber 100 is attached to a fishing line 210 of fishing pole 200. A fishing hook 212 is attached to the end of fishing line 210, wherein there is a user-defined length of fishing line 210 between turtle-shaped fishing bobber 100 and fishing hook 212.

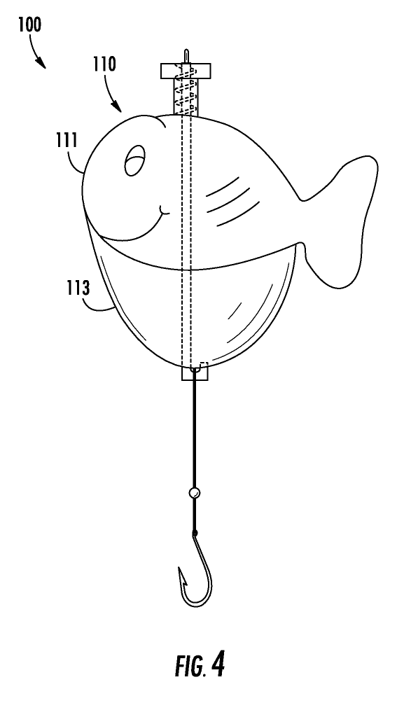

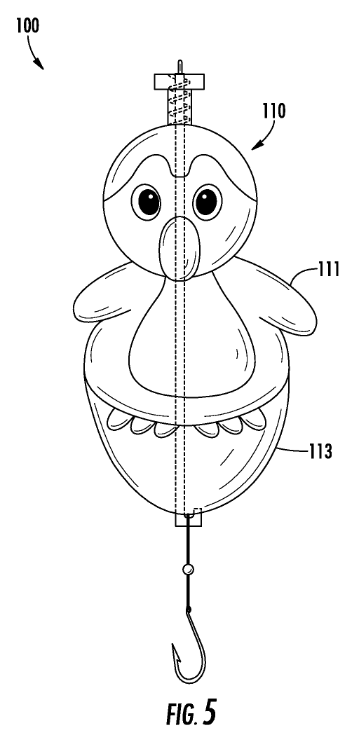

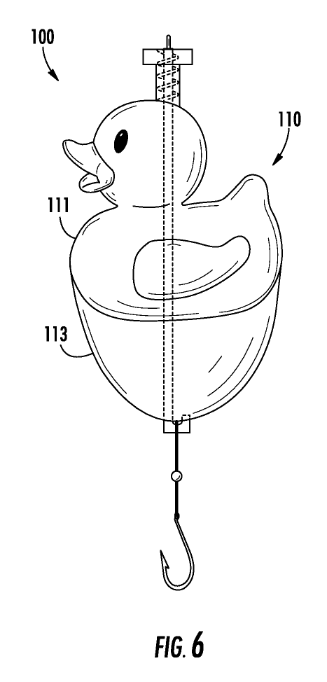

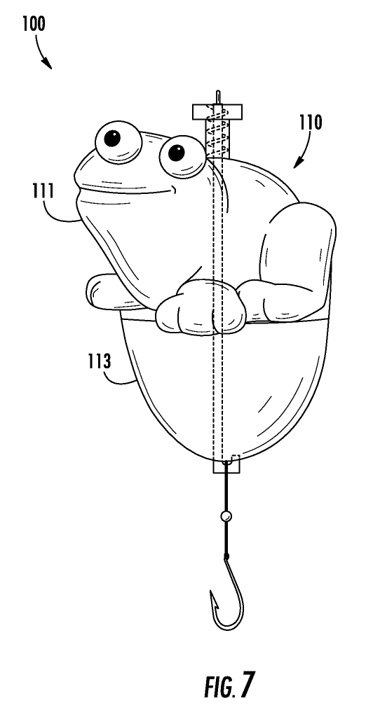

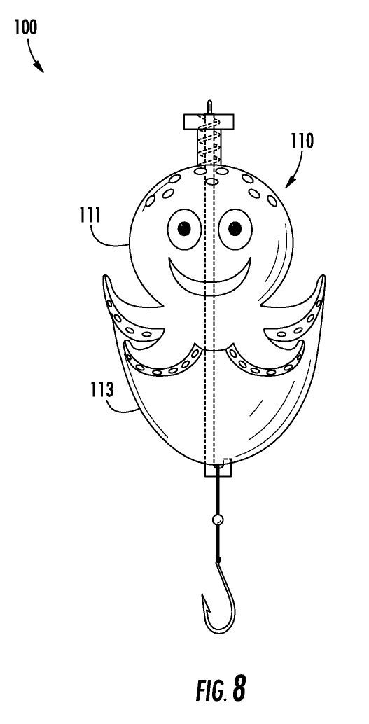

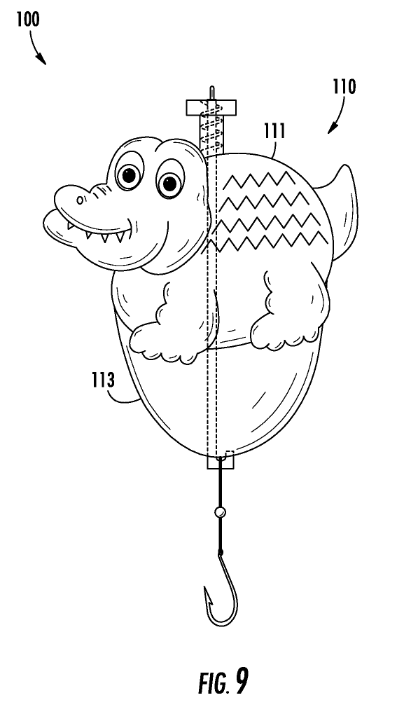

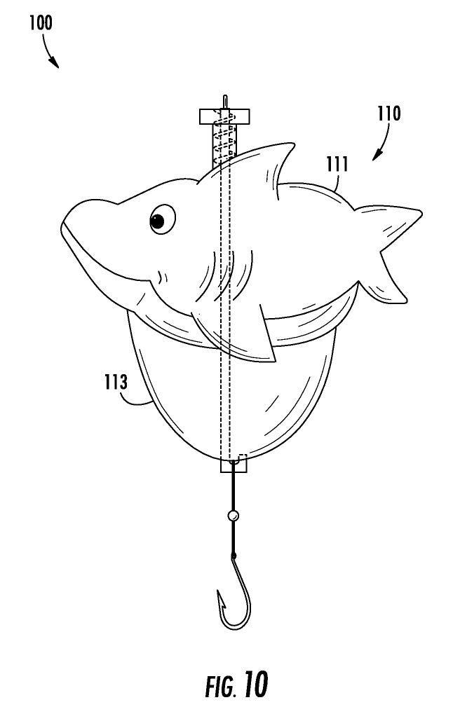

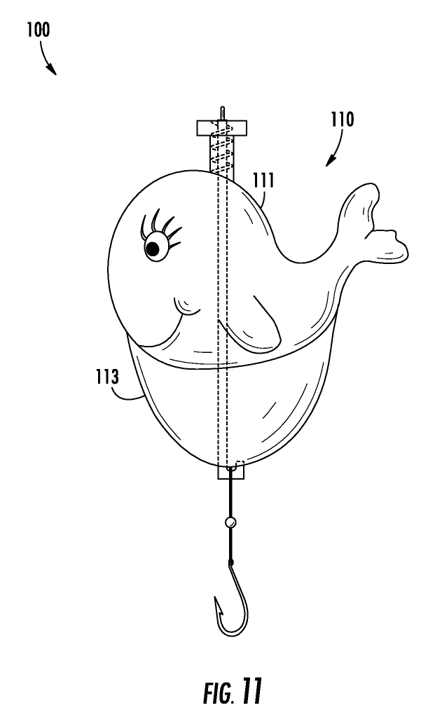

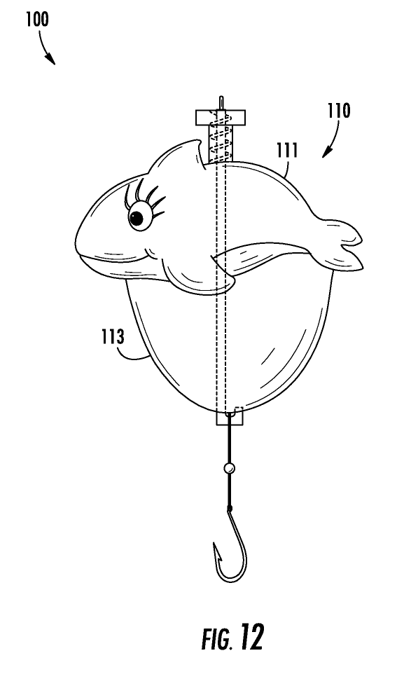

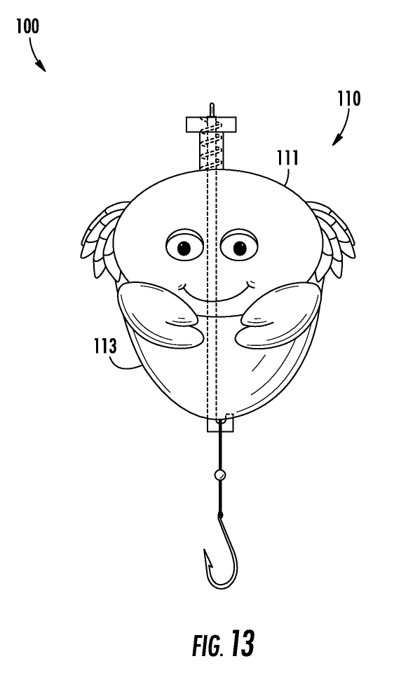

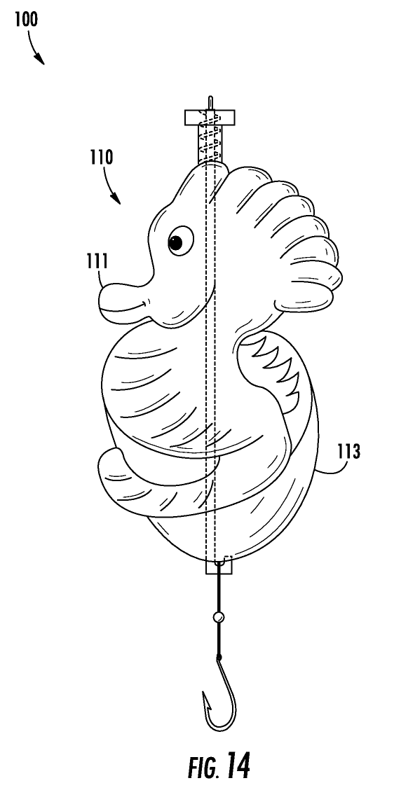

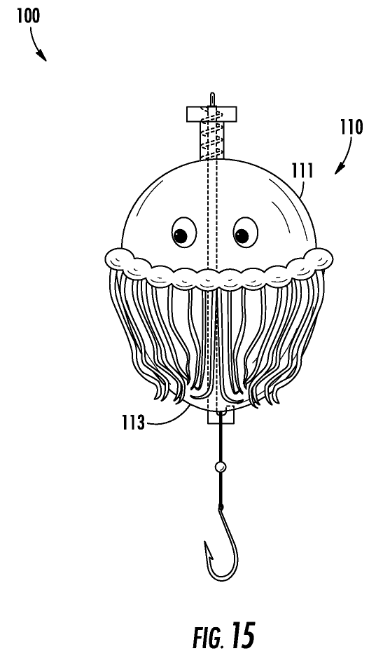

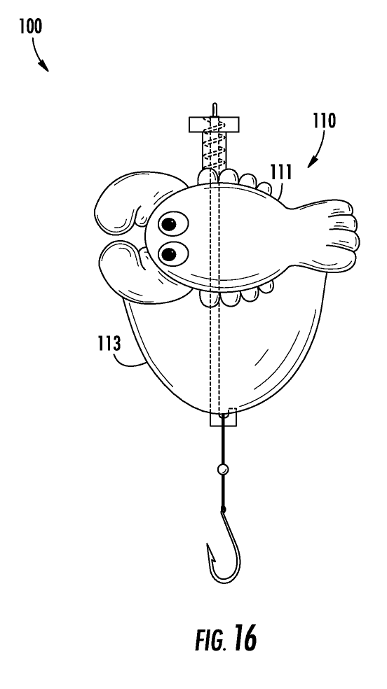

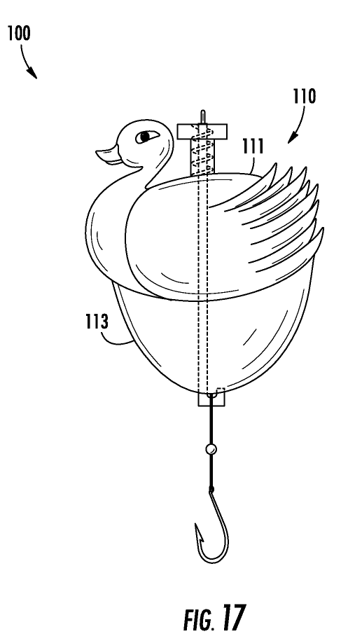

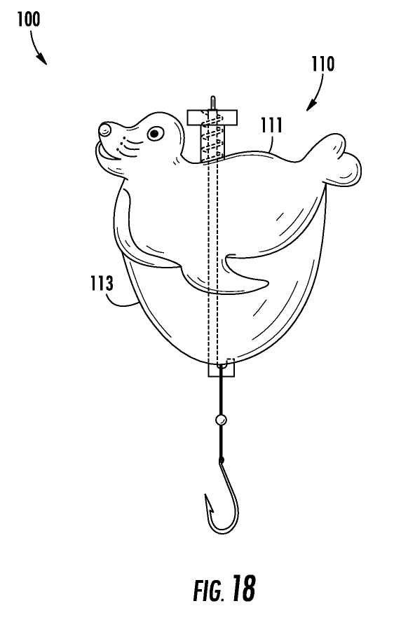

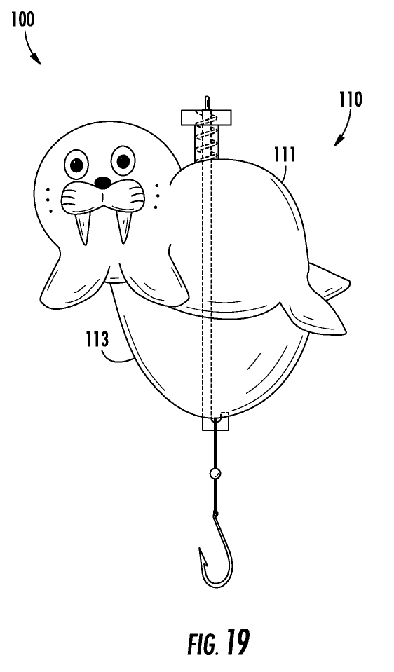

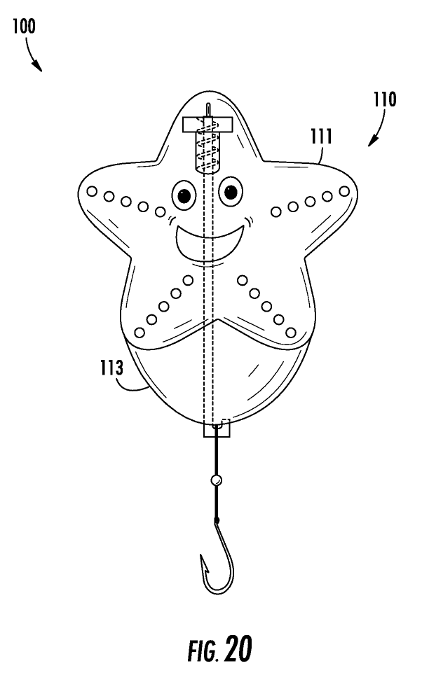

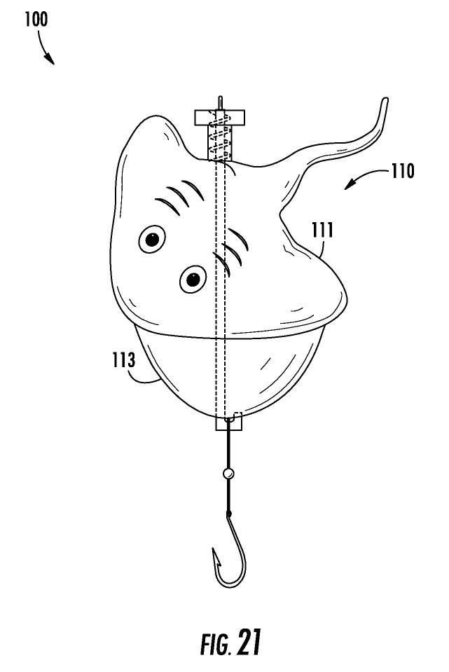

FIGS. 4 through 21 show other examples of the presently disclosed toy-shaped fishing bobbers 100 for helping to hold the attention and/or interest of children for fishing. For example, a fish-shaped fishing bobber 100 is shown in FIG. 4, a penguin-shaped fishing bobber 100 is shown in FIG. 5, a ducky-shaped fishing bobber 100 is shown in FIG. 6, a frog-shaped fishing bobber 100 is shown in FIG. 7, an octopus-shaped fishing bobber 100 is shown in FIG. 8, an alligator-shaped fishing bobber 100 is shown in FIG. 9, a shark-shaped fishing bobber 100 is shown in FIG. 10, a whale-shaped fishing bobber 100 is shown in FIG. 11, a dolphin-shaped fishing bobber 100 is shown in FIG. 12, a crab-shaped fishing bobber 100 is shown in FIG. 13, a seahorse-shaped fishing bobber 100 is shown in FIG. 14, a jellyfish-shaped fishing bobber 100 is shown in FIG. 15, a lobster-shaped fishing bobber 100 is shown in FIG. 16, a swan-shaped fishing bobber 100 is shown in FIG. 17, a seal-shaped fishing bobber 100 is shown in FIG. 18, a walrus-shaped fishing bobber 100 is shown in FIG. 19, a starfish-shaped fishing bobber 100 is shown in FIG. 20, and a stingray-shaped fishing bobber 100 is shown in FIG. 21.

In the toy-shaped fishing bobbers 100, the body 110 (regardless of specific shape) may be generally or partially pear-shaped. The body 110 may include an upper portion 111 and a lower portion 113, wherein the upper portion may include the toy-shape. The lower portion may be designed to be underwater and may be weighted to ensure proper orientation when floating in water. For example, when floating, the visible portion of the toy-shaped fishing bobbers 100 is the toy-shaped portion (e.g., upper portion 111). Further, shapes other than pear-shaped are possible, such as spherical or ovular shapes.

Body 110 of toy-shaped fishing bobbers 100 can be formed, for example, of foam, plastic, or rubber to which the elongated catch 112 and spring-loaded push button 114 are integrated. Further, body 110 of toy-shaped fishing bobbers 100 can be hollow, semi-solid, or solid. In one example, body 110 can be made using molded resin filled with foam beads or other floatation materials. In another example, body 110 can be hollow plastic or hollow rubber. In yet another example, body 110 can be made from hard foam. In still another example, body 110 can be an actual rubber ducky modified to include the elongated catch 112 and spring-loaded push button 114.

The presently disclosed toy-shaped fishing bobbers 100 may be in the range from about 2 inches to about 2.5 inches in height in one example, or may be about 2.25 inches in height in another example. Further, the presently disclosed toy-shaped fishing bobbers 100 can be unweighted bobbers or weighted bobbers.

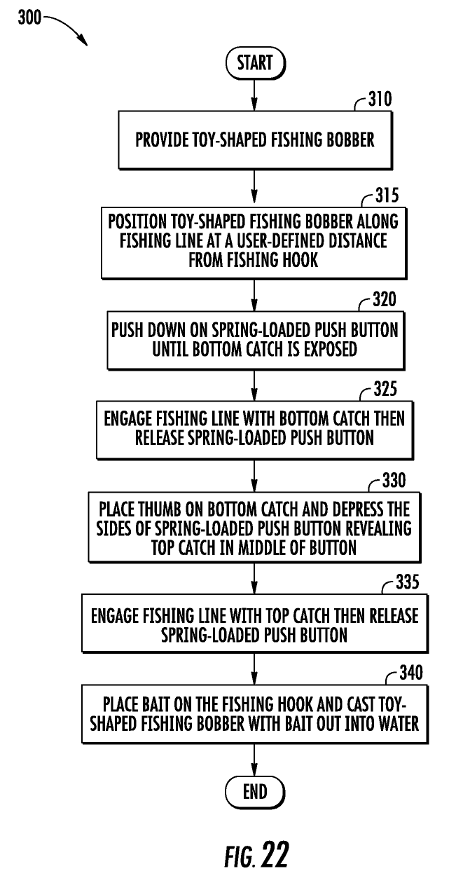

Referring now to FIG. 22 is a flow diagram of an example of a method 300 of using the presently disclosed toy-shaped fishing bobbers for helping to hold the attention and/or interest of children for fishing. Method 300 may include, but is not limited to, the following steps.

At a step 310, any one of the toy-shaped fishing bobbers is provided. For example, any one of the toy-shaped fishing bobbers 100 shown in FIG. 2 through FIG. 22 is provided.

At a step 315, the toy-shaped fishing bobber 100 is positioned along the fishing line at a user-defined distance from the fishing hook. For example, if the water is 5 feet deep, the user may position the toy-shaped fishing bobber 100 about three feet from the fishing hook.

At a step 320, the user pushes down on spring-loaded push button 114 until bottom catch 118 is exposed.

At a step 325, while bottom catch 118 is exposed, the user engages the fishing line with bottom catch 118 and then releases spring-loaded push button 114.

At a step 330, the user places his/her thumb or finger on bottom catch 118 and then depresses the sides of spring-loaded push button 114, thereby exposing top catch 116 in the middle of spring-loaded push button 114.

At a step 335, while top catch 116 is exposed, the user engages the fishing line with top catch 116 and then releases spring-loaded push button 114.

At a step 340, the user places bait on the fishing hook and then casts the toy-shaped fishing bobber 100 and bait out into the water and the fishing process begins. In so doing, toy-shaped fishing bobber 100 provides something cute and interesting for children to look at while they fish.

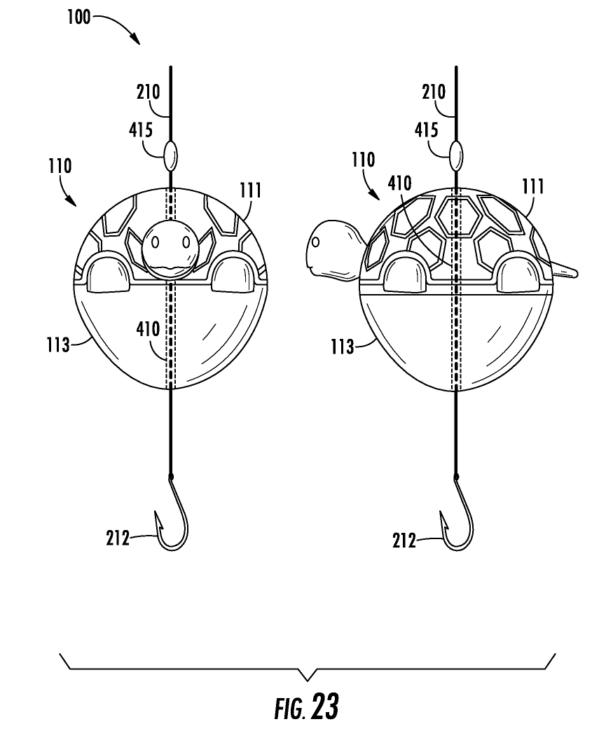

The presently disclosed toy-shaped fishing bobbers 100 are not limited to the spring-loaded catch type of bobber shown in FIG. 2 through 21, which use hardware like that of a standard round bobber. Rather, toy-shaped fishing bobbers 100 can be any other type of bobber and method 300 can be modified according to the type of toy-shaped fishing bobber 100. Other types of bobbers include, for example, round bobbers, slip bobbers, spring bobbers, peg bobbers, and the like. Accordingly, in another example, the presently disclosed toy-shaped fishing bobbers 100 can be a slip bobber, an example of which is shown in FIG. 23. For example, FIG. 23 shows another turtle-shaped fishing bobber 100, wherein this turtle-shaped fishing bobber 100 is a slip bobber. In this example, turtle-shaped fishing bobber 100 is absent the elongated catch 112, spring-loaded push button 114, top catch 116, and bottom catch 118. Instead, a hollow channel 410 only is provided in body 110 so that turtle-shaped fishing bobber 100 can be used in a slip bobber setup. In a slip bobber setup, fishing line 210 (from FIG. 2) is threaded through hollow channel 410. Fishing hook 212 is at the end of fishing line 210, below turtle-shaped fishing bobber 100. A bobber stop 415 (or peg) is installed on fishing line 210 above turtle-shaped fishing bobber 100. Optionally, a second bobber stop 415, peg, weight, or sinker can be installed on fishing line 210 below turtle-shaped fishing bobber 100.

In another example, the presently disclosed toy-shaped fishing bobbers 100 can be a peg bobber (not shown). In this example, a vertical line or slot is cut halfway through body 110. Then, the fishing line is placed in this slot. Then, a peg is placed down into the slot, locking the line in place.

Following long-standing patent law convention, the terms “a,” “an,” and “the” refer to “one or more” when used in this application, including the claims. Thus, for example, reference to “a subject” includes a plurality of subjects, unless the context clearly is to the contrary (e.g., a plurality of subjects), and so forth.

Throughout this specification and the claims, the terms “comprise,” “comprises,” and “comprising” are used in a non-exclusive sense, except where the context requires otherwise. Likewise, the term “include” and its grammatical variants are intended to be non-limiting, such that recitation of items in a list is not to the exclusion of other like items that can be substituted or added to the listed items.

For the purposes of this specification and appended claims, unless otherwise indicated, all numbers expressing amounts, sizes, dimensions, proportions, shapes, formulations, parameters, percentages, quantities, characteristics, and other numerical values used in the specification and claims, are to be understood as being modified in all instances by the term “about” even though the term “about” may not expressly appear with the value, amount or range. Accordingly, unless indicated to the contrary, the numerical parameters set forth in the following specification and attached claims are not and need not be exact, but may be approximate and/or larger or smaller as desired, reflecting tolerances, conversion factors, rounding off, measurement error and the like, and other factors known to those of skill in the art depending on the desired properties sought to be obtained by the disclosed subject matter. For example, the term “about,” when referring to a value can be meant to encompass variations of, in some embodiments, ±100% in some embodiments ±50%, in some embodiments ±20%, in some embodiments ±10%, in some embodiments ±5%, in some embodiments ±1%, in some embodiments ±0.5%, and in some embodiments ±0.1% from the specified amount, as such variations are appropriate to perform the disclosed methods or employ the disclosed compositions.

Further, the term “about” when used in connection with one or more numbers or numerical ranges, should be understood to refer to all such numbers, including all numbers in a range and modifies that range by extending the boundaries above and below the numerical values set forth. The recitation of numerical ranges by endpoints includes all numbers, e.g., whole integers, including fractions thereof, subsumed within that range (for example, the recitation of 1 to 5 includes 1, 2, 3, 4, and 5, as well as fractions thereof, e.g., 1.5, 2.25, 3.75, 4.1, and the like) and any range within that range.

Although the foregoing subject matter has been described in some detail by way of illustration and example for purposes of clarity of understanding, it will be understood by those skilled in the art that certain changes and modifications can be practiced within the scope of the appended claims.

That which is claimed:

1. A fishing float, comprising:
a. a buoyant body, comprising:
i. an upper portion having a general shape comprising one of a toy, character, or animal; and
ii. a lower portion, wherein the lower portion extends from a bottom of the upper portion, and wherein the upper portion and the lower portion are shaped and configured together such that when floating in water at least a portion of the upper portion is visible above the water; and
b. a mechanism for adjustably securing the buoyant body to a fishing line.

2. The fishing float of claim 1, wherein the lower portion is one of a generally ovular, pear, or spherical shape.

3. The fishing float of claim 1, wherein the mechanism for securing the buoyant body to a fishing line comprises:
a. an elongated catch, comprising a top catch disposed at the upper portion of the buoyant body and a bottom catch disposed at the lower portion of the buoyant body;
b. a spring-loaded push button configured to actuate one of the top catch or bottom catch; and
wherein the top catch and bottom catch are configured to engage with the fishing line to secure the buoyant body thereto.

4. The fishing float of claim 1, further comprising a vertically orientated hollow channel formed through upper and lower portions of the buoyant body, wherein the hollow channel is configured to receive fishing line threaded therethrough, and wherein the mechanism for securing the buoyant body to a fishing line comprises at least one bobber stop, wherein the bobber stop is disposed at one or both of the top and/or bottom of the buoyant body where the fishing line enters and exits the hollow channel.

5. The fishing float of claim 1, wherein the lower portion of the buoyant body is weighted.

6. The fishing float of claim 1, wherein the lower portion of the buoyant body is configured to be underwater when in use.

7. The fishing float of claim 1, wherein the buoyant body is made of at least one of foam, cork, plastic, wood, or rubber material.

8. The fishing float of claim 7, wherein the upper and lower portions of the buoyant body are made of the same material.

9. The fishing float of claim 7, wherein the upper and lower portions of the buoyant body are made of different materials.

10. The fishing float of claim 1, wherein the upper and/or lower portions of the buoyant body are one of hollow, semi-solid, or solid.

11. The fishing float of claim 1, further comprising a vertically orientated slot formed in the upper and lower portions of the buoyant body, wherein the slot extends about halfway through a width of the buoyant body, and is configured to receive fishing line therein, and wherein the mechanism for securing the buoyant body to a fishing line comprises at least one peg, wherein the peg is inserted into the slot.

12. A fishing apparatus, comprising:
a. a fishing rod;
b. a fishing reel attached to the fishing rod, the fishing reel comprising fishing line; and
c. a fishing float attached to the fishing line, the fishing float comprising:
i. a buoyant body, comprising:
1. an upper portion having a general shape comprising one of a toy, character, or animal; and
2. a lower portion, wherein the lower portion extends from a bottom of the upper portion, and wherein the upper portion and the lower portion are shaped and configured together such that when floating in water at least a portion of the upper portion is visible above the water; and
ii. a mechanism for adjustably securing the buoyant body to the fishing line.
